(19) United States
(12) Patent Application Publication
(10) Pub. No.: US 2026/0067550 A1
(43) Pub. Date: Mar. 5, 2026

(54) IMAGING APPARATUS

(71) Applicant: FUJIFILM Corporation, Tokyo (JP)

(72) Inventors: Takanori YAMADA, Saitama-shi (JP); Masaaki TAKAGI, Saitama-shi (JP); Toshiaki NAGAI, Saitama-shi (JP)

(73) Assignee: FUJIFILM Corporation, Tokyo (JP)

(21) Appl. No.: 19/311,845

(22) Filed: Aug. 27, 2025

(30) Foreign Application Priority Data
Aug. 28, 2024 (JP) 2024-146631

(51) Int. Cl. H04N 23/53; H04N 23/63

(52) U.S. Cl. CPC H04N 23/53; H04N 23/632

(57) ABSTRACT

Provided is an imaging apparatus including a monitor unit provided in a main body.

A digital camera 10 includes a monitor unit 50 provided in a main body 12, in which the monitor unit 50 has one display device 60, the display device 60 is provided with a display region 52 and a display region 54, and the digital camera 10 further includes a cover member 80 having an opening portion 82 and an opening portion 84 that expose the display region 52 and the display region 54, respectively, in a separated manner.

### CROSS-REFERENCE TO RELATED APPLICATION

The present application claims priority under 35 U.S.C § 119(a) to Japanese Patent Application No. 2024-146631 filed on Aug. 28, 2024, which is hereby expressly incorporated by reference, in its entirety, into the present application.

### BACKGROUND OF THE INVENTION

### 1. Field of the Invention

The present invention relates to an imaging apparatus comprising a monitor unit provided in a main body.

### 2. Description of the Related Art

The digital camera disclosed in JP2004-207774A comprises two imaging elements having different sizes in the imaging system, and a subject image incident from a lens is separated by a half mirror and imaged on the two imaging elements.

The subject images captured by the respective imaging elements are combined and displayed on the screen of the display. For example, the captured image captured by the smaller imaging element is displayed in a superimposed manner on a central portion of the captured image captured by the larger imaging element.

### SUMMARY OF THE INVENTION

One embodiment according to the technology of the present disclosure provides an imaging apparatus comprising a monitor unit provided in a main body.

According to a first aspect of the present invention, an imaging apparatus comprises a monitor unit in a main body, in which the monitor unit has one display device, the display device is provided with a first display region and a second display region, and the imaging apparatus further comprises a cover member having a first opening portion and a second opening portion that expose the first display region and the second display region, respectively, in a separated manner.

According to a second aspect of the present invention, in the imaging apparatus according to the first aspect, the display device has a touch panel function, and the display device includes a first operation input member corresponding to the first display region and a second operation input member corresponding to the second display region.

According to a third aspect of the present invention, in the imaging apparatus according to the second aspect, the first operation input member and the second operation input member are made of a glass member.

According to a fourth aspect of the present invention, in the imaging apparatus according to any one of the first to the third aspects, the cover member is fixed to the monitor unit, and a fixing member that fixes the cover member and the display device to each other is provided between the cover member and the display device.

According to a fifth aspect of the present invention, in the imaging apparatus according to the fourth aspect, the fixing member is a double-sided adhesive tape.

According to a sixth aspect of the present invention, in the imaging apparatus according to any one of the first to fifth aspects, the monitor unit is provided on a main body rear surface that is a rear surface of the main body, and a lens unit having an optical axis is provided on a main body front surface opposite to the main body rear surface, and in a case where the main body rear surface is viewed in a direction along the optical axis, the optical axis is positioned in the second opening portion.

According to a seventh aspect of the present invention, in the imaging apparatus according to the sixth aspect, a finder part is provided on the main body rear surface, and in a case where the main body rear surface is viewed in a direction along the optical axis, the first opening portion and the finder part are provided so as to include a first axis along a direction intersecting the optical axis.

According to an eighth aspect of the present invention, in the imaging apparatus according to the seventh aspect, in a case where the main body rear surface is viewed in a direction along the optical axis, the finder part is disposed at an upper left corner portion or an upper right corner portion of the main body rear surface, the first opening portion is disposed at a lower position of the finder part on the first axis, and the second opening portion is disposed on a right side or a left side of the first opening portion.

According to a ninth aspect of the present invention, in the imaging apparatus according to any one of the first to eighth aspects, the first display region is a display region in which information related to imaging is displayed.

According to a tenth aspect of the present invention, in the imaging apparatus according to any one of the first to ninth aspects, the second display region is a display region in which a captured image is displayed.

According to an eleventh aspect of the present invention, in the imaging apparatus according to the tenth aspect, the captured image is displayed in the second display region with a vertically long aspect ratio.

According to a twelfth aspect of the present invention, in the imaging apparatus according to any one of the first to eleventh aspects, the first opening portion has a smaller area than the second opening portion.

According to a thirteenth aspect of the present invention, in the imaging apparatus according to the twelfth aspect, the second opening portion has a vertically long quadrangular shape.

### BRIEF DESCRIPTION OF THE DRAWINGS

FIG. 1 is a front view of a digital camera according to an embodiment.

FIG. 2 is a rear view of the digital camera shown in FIG. 1.

FIG. 3 is a perspective view of a monitor.

FIG. 4 is an exploded perspective view of a monitor unit including a cover member.

FIG. 5 is a perspective view of a monitor unit excluding a cover member.

FIG. 6 is an exploded perspective view of the monitor unit shown in FIG. 5.

FIG. 7 is a main part enlarged perspective view showing a state in which the cover member is fixed to the display device by a double-sided adhesive tape.

FIG. 8 is a rear view of the digital camera showing disposition positions of two display regions with respect to a main body rear surface.

### DESCRIPTION OF THE PREFERRED EMBODIMENTS

First, an outline of the technology of the present disclosure will be described. An imaging apparatus according to the technology of the present disclosure comprises a monitor unit provided in a main body, in which the monitor unit has one display device, and the one display member has a first display region and a second display region as display regions. In addition, the imaging apparatus according to the technology of the present disclosure comprises a cover member, in which the cover member has a first opening portion and a second opening portion that expose the first display region and the second display region, respectively, in a separated manner. With this configuration, the user who views the two images displayed in the first display region and the second display region can easily visually grasp the difference between the two images.

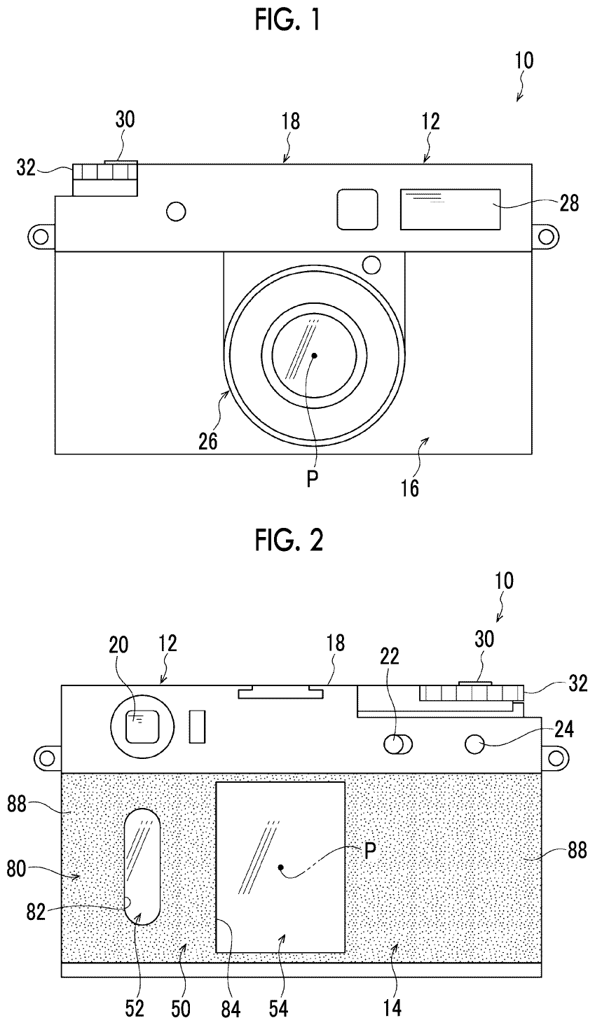

Hereinafter, embodiments of the technology of the present disclosure will be described with reference to the drawings. FIG. 1 is a front view of a digital camera 10 according to the embodiment as viewed from a front side, and FIG. 2 is a rear view of the digital camera 10 as viewed from a rear side. The digital camera 10 is an example of an imaging apparatus according to the embodiment of the present invention.

The front surface is a surface facing the subject side in a case where the subject is imaged by the digital camera 10, and the rear surface is a surface opposite to the front surface and facing the user side who handles the digital camera 10.

As shown in FIGS. 1 and 2, a digital camera 10 comprises a main body 12 which is a housing. The main body 12 has a main body rear surface 14 which is a rear surface side, a main body front surface 16 which is opposite to the main body rear surface 14, and a main body upper surface 18 which is an upper surface side.

A monitor unit 50, which will be described later, is provided on the main body rear surface 14. The monitor unit 50 has two display regions 52 and a display region 54.

In addition, the main body rear surface 14 is provided with a finder part 20, a slide switch 22 that switches an imaging mode (also referred to as an imaging mode) between a still image (STILL) and a motion picture (MOVIE), and a play button 24 that gives an instruction to playback a still image or a motion picture. The main body rear surface 14 is an example of a main body rear surface according to the embodiment of the present invention.

A lens unit 26 and a strobe light emission unit 28 are provided on the main body front surface 16. The lens unit 26 has an optical axis P that is an imaging optical axis. The lens unit 26 may be an interchangeable lens unit that is attachable to and detachable from the main body 12, or may be a lens unit that is integrally configured with the main body 12 and is not attachable to and detachable from the main body 12. The strobe light emission unit 28 automatically emits light in a case where the amount of imaging light is insufficient, or forcibly emits light in a case where an instruction to emit light is given. The main body front surface 16, the lens unit 26, and the optical axis P are examples of a main body front surface, a lens unit, and an optical axis of the present invention, respectively.

A release button 30 and a dial 32 are provided on the main body upper surface 18. The release button 30 is half-pressed and fully pressed by the user. The digital camera 10 is set to an imaging start state by a half push operation of the release button 30 and is set to an imaging exposure state by a full push operation.

The dial 32 is operated by the user in a case of setting each operation mode of the imaging system and the playback system. By operating the dial 32, for example, an imaging mode, a playback mode, and a setting mode are selectively set as the operation mode of the digital camera 10.

The imaging mode is an operation mode in which the digital camera 10 is caused to execute imaging of a still image or a video. The playback mode is an operation mode in which a still image or a video image captured in the imaging mode is played back. The setting mode is an operation mode in which various set values related to imaging are set for the digital camera 10. The operation mode set by the operation of the dial 32 is not limited to the above three modes.

Although not shown, the digital camera 10 comprises a controller. The controller is built in the main body 12 and controls the entire digital camera 10.

In addition, an image sensor (not shown) is provided in the main body 12. The image sensor is, for example, a complementary metal oxide semiconductor (CMOS) image sensor. The subject light is imaged on a light-receiving surface of the CMOS image sensor through the optical system of the lens unit 26, and image data indicating an image of the subject is generated by the CMOS image sensor. The image sensor is not limited to the CMOS image sensor, and may be, for example, other types of image sensors such as a charge coupled devices (CCD) image sensor.

### Monitor Unit

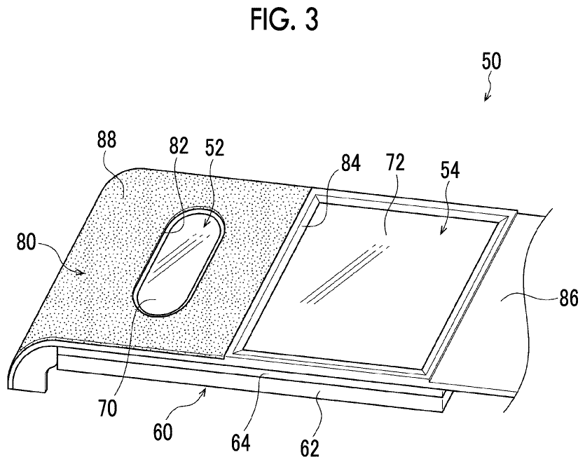

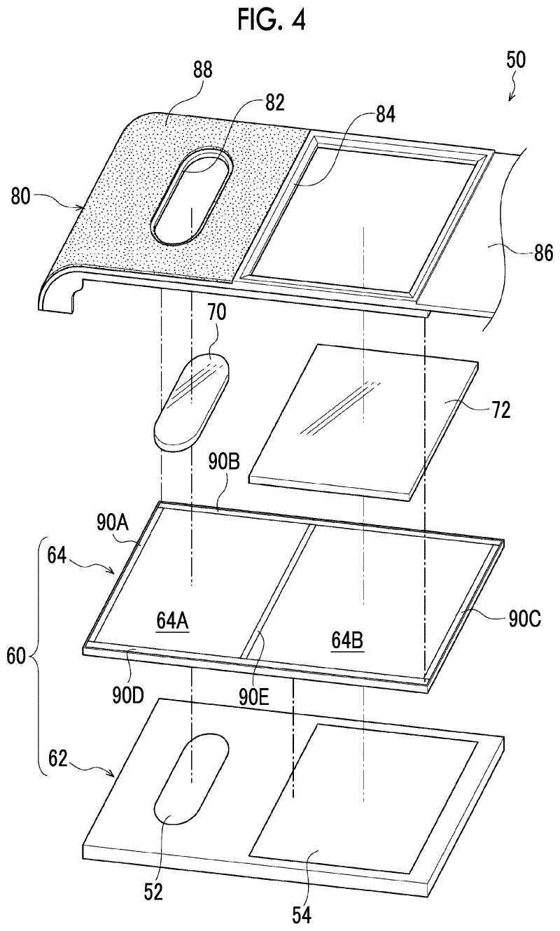

Next, the monitor unit 50 provided on the main body rear surface 14 will be described. FIG. 3 is a perspective view of the monitor unit 50, and FIG. 4 is an exploded perspective view showing a plurality of components constituting the monitor unit 50 shown in FIG. 3 to be spaced from each other.

As shown in FIGS. 3 and 4, the monitor unit 50 comprises one display device 60 and two glass plates 70 and 72. In addition, FIGS. 3 and 4 show a cover member 80 provided in the digital camera 10, and the cover member 80 is fixed to the monitor unit 50 as will be described later.

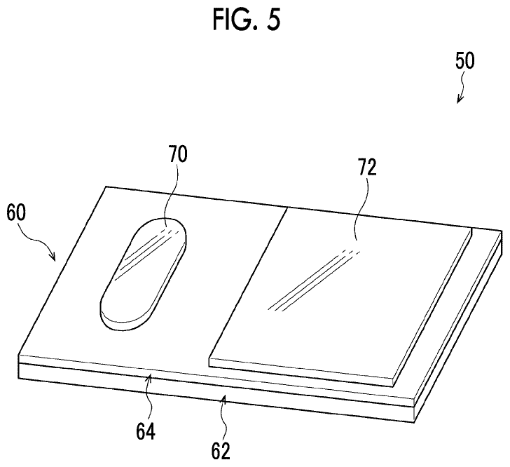

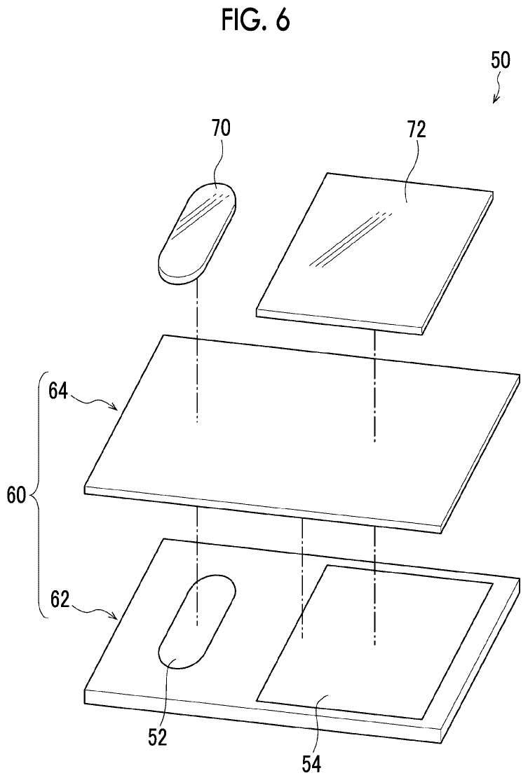

FIG. 5 is a perspective view of the monitor unit 50 excluding the cover member 80, and FIG. 6 is an exploded perspective view showing a plurality of components constituting the monitor unit 50 shown in FIG. 5 to be spaced from each other.

As shown in the respective exploded perspective views of FIGS. 4 and 6, the display device 60 includes a display member 62 and a touch panel member 64. The display device 60 is configured by laminating a touch panel member 64 on a surface (surface on the display region side) of a display member 62. Accordingly, the display device 60 has a touch panel function by the touch panel member 64. The configuration of the touch panel member 64 of the present embodiment is an example, the disposition position of the touch panel member 64 is optional, and the display device 60 may have a touch panel function.

The display device 60 of the present example is an on-cell type in which the touch panel member 64 is laminated on a surface of the display member 62 on the display region side. However, the present invention is not limited thereto, and for example, an in-cell type display device can also be applied.

### Display Member

The display member 62 is, for example, a liquid crystal display configured in a rectangular shape. However, the liquid crystal display is not limited, and other types of displays such as an EL display (for example, an organic EL display or an inorganic EL display) may be used.

In the display member 62, the display region 52 and the display region 54 are provided to be spaced from each other. In a case where the main body rear surface 14 is viewed in a direction view along the optical axis P, the display region 52 is provided in a part of a left half region of the entire region of the display member 62, and the display region 54 is provided in a part of a right half region of the entire region of the display member 62.

In the display member 62 of the present example, the entire region is not configured as the display region, and two regions provided to be spaced apart from each other in the left and right directions among the entire region are configured as the display regions 52 and 54. Accordingly, two display regions 52 and 54 are provided in one display member 62. The display region 52 and the display region 54 are each an example of a first display region and a second display region of the present invention.

As an example, the following image, character information, and the like are displayed in the display region 54.

For example, in a case where the imaging mode is selected as the operation mode of the digital camera 10, the live view image is displayed in the display region 54. The live view image is an image based on imaging data obtained by imaging by the image sensor.

In addition, in a case where an instruction to perform imaging for a still image is given to the digital camera 10 by the full push operation of the release button 30, a still image is displayed in the display region 54. The still image is an image based on imaging data obtained by imaging by the image sensor. In this case, for example, the captured image is displayed in the display region 54 in a vertically long aspect ratio. This captured image is an image corresponding to a half-size aspect ratio obtained by dividing the L-size into two.

In addition, in a case where the playback mode is selected as the operation mode of the digital camera 10, a playback image is displayed in the display region 54. The playback image is a still image or a video image stored in an image storage medium built in the main body 12 or an external storage medium externally attached to the main body 12.

In a case where the setting mode is selected as the operation mode of the digital camera 10, a menu screen on which various menus can be selected and a setting image for setting various setting values and the like related to imaging are displayed in the display region 54.

On the other hand, for example, the following image is displayed in the display region 52.

For example, in a case where the imaging mode is selected as the operation mode of the digital camera 10, an image such as a character or a symbol indicating information related to imaging (for example, an auto mode, a scene mode, a backlight mode, or the like) is displayed in the display region 52. The image displayed in the display region 52 may display not only the information related to the imaging but also, for example, information related to the playback mode in a case where the playback mode is selected as the operation mode, and information related to the setting mode in a case where the setting mode is selected as the operation mode.

The image displayed in the display region 52 is not limited to the information indicating the mode as described above, and may be, for example, a video image or a still image captured by the image sensor. In this case, for example, it is also possible to display an image having a different magnification in the display region 52 with respect to the moving image and the still image displayed in the display region 54.

The display region 52 of the present example is, for example, a vertically long elliptical display region. In addition, the display region 54 of the present example is, for example, a vertically long quadrangular display region having a larger area than the display region 52. However, the present invention is not limited to this, and the size and shape of the display region 52 and the display region 54 are optional.

### Touch Panel Member

The touch panel member 64 is a transmissive touch panel configured in a rectangular shape, and is laminated on a surface of the display member 62 on the display region side.

In a case where contact by a finger or an instruction member such as a stylus pen is detected, the touch panel member 64 receives various instructions from the user. For example, the various instructions refer to an instruction to display the menu screen, an instruction to select one or a plurality of menus, an instruction to confirm selected content, an instruction to cancel the selected content, and various instructions such as zoom-in, zoom-out, and frame advance.

### Glass Plate

The glass plate 70 and the glass plate 72 are, for example, glass plates having high transparency and high strength, respectively. The glass plate 70 has a vertically long elliptical shape equal to the size and the shape of the display region 52, and the glass plate 72 has a vertically long quadrangular shape equal to the size and the shape of the display region 54.

The glass plate 70 and the glass plate 72 are laminated on the display region 52 and the display region 54 with the touch panel member 64 interposed therebetween, respectively. That is, the glass plate 70 corresponding to the display region 52 and the glass plate 72 corresponding to the display region 54 are laminated on the surface of the display device 60. In a case where the touch panel member 64 receives an instruction from the user, the glass plate 70 and the glass plate 72 function as operation input members, respectively. The glass plate 70 and the glass plate 72 are each an example of a first operation input member and a second operation input member of the present invention, and are an example of a glass member of the present invention.

### Cover Member

As shown in FIGS. 3 and 4, the cover member 80 is a member that constitutes a part of the main body rear surface 14. The cover member 80 has an opening portion 82 and an opening portion 84 that expose the display region 52 and the display region 54, respectively, in a separated manner. The opening portion 82 has a vertically long elliptical shape equal to the size and the shape of the display region 52, and the opening portion 84 has a vertically long quadrangular shape equal to the size and the shape of the display region 54. The opening portion 82 has a smaller area than the opening portion 84. The opening portion 82 and the opening portion 84 are each an example of a first opening portion and a second opening portion of the present invention.

In a case where the image is displayed in the display region 52, the user can visually recognize the image displayed in the display region 52, which is transmitted through the touch panel member 64 and the glass plate 70, through the opening portion 82. In addition, in a case where the image is displayed in the display region 54, the user can visually recognize the image displayed in the display region 54, which has been transmitted through the touch panel member 64 and the glass plate 72, through the opening portion 84.

The cover member 80 has a cover substrate 86 having a plate shape and made of a resin or metal, and a leather sheet 88 attached to a surface of the cover substrate 86. A user who grips the main body 12 of the digital camera 10 touches the sheet 88 to improve gripability with respect to the main body 12. In FIGS. 3 and 4, the sheet 88 present on the left side of the opening portion 84 is shown, but the sheet 88 present on the right side of the opening portion 84 is not shown.

A double-sided adhesive tape 90A, 90B, 90C, 90D, or 90E that fixes the cover member 80 and the display device 60 to each other is provided between the cover member 80 (cover substrate 86) and the display device 60. Therefore, the cover member 80 is fixed to the touch panel member 64 of the display device 60 by the double-sided adhesive tapes 90A to 90E. Each of the double-sided adhesive tapes 90A to 90E has a strip shape.

Among the double-sided adhesive tapes 90A to 90E, four double-sided adhesive tapes 90A to 90D are bonded along four sides of the touch panel member 64, and one double-sided adhesive tape 90E is bonded along an imaginary line (not shown) that divides the entire region of the touch panel member 64 into left and right parts.

The entire region of the touch panel member 64 is divided into a left half region 64A laminated on the display region 52 side and a right half region 64B laminated on the display region 54 side by the double-sided adhesive tape 90E. The double-sided adhesive tapes 90A to 90E are attached to a flat surface of the surface of the touch panel member 64 on which the glass plates 70 and 72 are not laminated.

The cover member 80 is bonded and fixed to the touch panel member 64 by five double-sided adhesive tapes 90A to 90E. In this case, the invasion of dust or mist that tries to invade from the outside of the four sides of the touch panel member 64 toward the region 64A and the region 64B of the touch panel member 64 can be prevented by the four double-sided adhesive tapes 90A to 90D. In addition, the invasion of dust or mist that tries to invade from the opening portion 84 toward the region 64A of the touch panel member 64 can be prevented by one double-sided adhesive tape 90E.

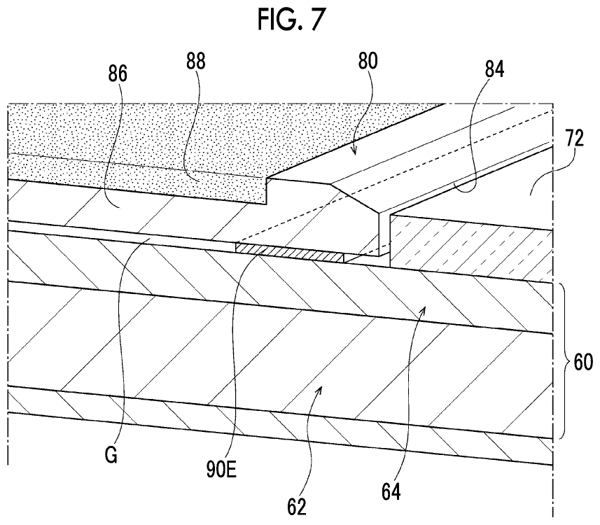

FIG. 7 is an enlarged perspective view of main parts showing a state in which the cover member 80 is adhered and fixed to the touch panel member 64 by the double-sided adhesive tape 90E.

As shown in FIG. 7, a gap G is generated between the cover member 80 and the touch panel member 64 (region 64A) by the thickness of the double-sided adhesive tape 90E, but the gap G is sealed by the double-sided adhesive tapes 90A, 90B, 90C, and 90E in FIG. 4. Accordingly, it is possible to prevent dust or mist from invading the gap G from the outside.

The double-sided adhesive tapes 90A to 90E are examples of a fixing member according to the embodiment of the present invention and are examples of a double-sided adhesive tape according to the embodiment of the present invention. That is, in the present example, the double-sided adhesive tape 90A to 90E is exemplified as the fixing member, but the present invention is not limited thereto. An adhesive may be used as the fixing member as long as the cover member 80 can be fixed to the touch panel member 64.

With the digital camera 10 of the embodiment configured as described above, the monitor unit 50 is provided on the main body rear surface 14, the monitor unit 50 has one display device 60, and one display device 60 has the display region 52 and the display region 54. In addition, the digital camera 10 comprises the cover member 80, and the cover member 80 has the opening portion 82 and the opening portion 84 that expose the display region 52 and the display region 54, respectively, in a separated manner. With such a configuration, the user who views the two images displayed in the display region 52 and the display region 54 can easily visually grasp a difference between the two images.

In addition, each image displayed in the display region 52 and the display region 54 is visually recognized by the user through the opening portion 82 and the opening portion 84, respectively. In this case, in a case where the opening edge portions of the opening portions 82 and 84 have a stepped shape (see FIG. 3) in which the opening area is reduced as the opening edge portions approach the touch panel member 64, the two images are emphasized because the opening edge portions are seen as window frames, and as a result, the difference between the two images can be more easily grasped.

On the other hand, in a case where a monitor unit having two display regions on the main body rear surface is configured, the monitor unit is configured using two display devices for each display region in the related art. On the other hand, the digital camera 10 of the embodiment includes two display regions 52 and 54 on one display device 60 to constitute the monitor unit 50.

Accordingly, as compared with the previous case where the monitor unit is configured by attaching two display devices to the main body of the digital camera, the digital camera 10 of the embodiment can configure the monitor unit 50 having the two display regions 52 and 54 by attaching one display device 60 to the main body 12, and thus, the workability of assembling the monitor unit 50 is improved.

In addition, according to the digital camera 10 of the embodiment, since the display device 60 with a touch panel function is employed as the display device, it is easy to receive an instruction from a user with respect to the digital camera 10. Accordingly, the operability of the digital camera 10 is improved.

In addition, with the digital camera 10 of the embodiment, since the configuration in which the glass plate 70 corresponding to the display region 52 and the glass plate 72 corresponding to the display region 54 are laminated on the surface of the display device 60 is employed, the display regions 52 and 54 can be protected by the glass plates 70 and 72.

In addition, with the digital camera 10 of the embodiment, since the monitor unit 50 and the cover member 80 are fixed by the double-sided adhesive tapes 90A to 90E, the workability of assembling the cover member 80 to the monitor unit 50 is improved.

Next, a preferred disposition position of the opening portion 82 (corresponding to the display region 52) and the opening portion 84 (corresponding to the display region 54) on the main body rear surface 14 will be described.

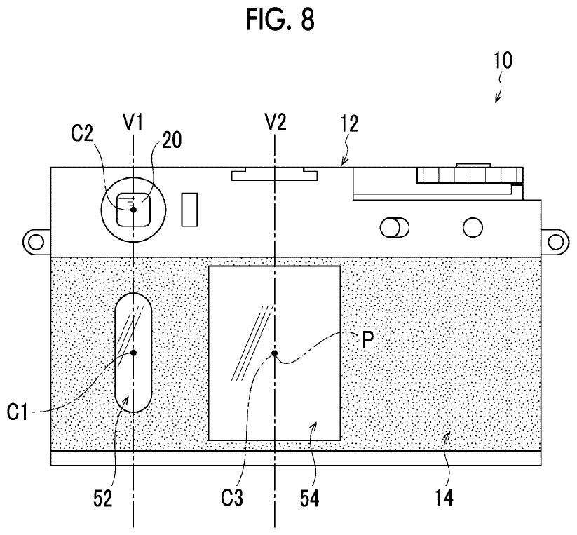

FIG. 8 is a rear view of the digital camera 10 showing the disposition positions of the opening portion 82 and the opening portion 84 with respect to the main body rear surface 14. FIG. 8 is the same drawing as FIG. 2, but only necessary reference numerals are added as compared with FIG. 2 in order to easily describe the above-described disposition position.

As shown in FIG. 8, in a case where the main body rear surface 14 is viewed in a direction view along the optical axis P, in other words, in a case where the main body rear surface 14 is viewed with a direction of the optical axis P being parallel to a horizontal direction, the finder part 20 is disposed at an upper left corner portion of the main body rear surface 14, and the opening portion 82 is disposed at a lower position of the finder part 20. In addition, the opening portion 84 is disposed on the right side of the opening portion 82, and the optical axis P is disposed in the opening portion 84.

By disposing the opening portion 82 at the above-described position, the user who looks through the finder part 20 can check the imaging information displayed in the display region 52 only by shifting the line of sight to the lower side in the vertical direction. In addition, by disposing the opening portion 84 at the above-described position, the user who has checked the imaging information can check the captured image of the display region 54 displayed via the opening portion 84 by only shifting the visual line to the right side in the horizontal direction. In this case, since the optical axis P is disposed in the opening portion 84, the user can easily check the position of the subject with respect to the user. As a result, the operability of the digital camera 10 by the user is improved.

As a form of a preferable disposition position of the opening portion 82, the opening portion 82 may be provided on the vertical axis V1 passing through the finder part 20. That is, it is preferable that the opening portion 82 and the finder part 20 are provided to include the same vertical axis V1. The vertical axis V1 is an axis along the vertical direction among a plurality of axes along a direction intersecting the optical axis P, and is an example of a first axis of the present invention.

In addition, as a more preferable form of the disposition position of the opening portion 82, the opening portion 82 may be provided such that the centroid position C1 of the opening portion 82 is on a vertical axis V1 passing through the centroid position C2 of the finder part 20. In this case, the centroid position C1 is a centroid position in a case where the opening portion 82 is assumed to be a rectangle, and the centroid position C2 is a centroid position in a case where the finder part 20 is assumed to be a square or a rectangle.

On the other hand, as a form of a preferable disposition position of the opening portion 84, the opening portion 84 may be provided on a vertical axis V2 passing through the centroid position C3 of the opening portion 84 and the optical axis P. Further, as a form of a more preferable disposition position, the opening portion 84 may be provided at a position where the centroid position C3 of the opening portion 84 coincides with the optical axis P.

By disposing the opening portion 82 and the opening portion 84 at the above-described preferred positions, the operability of the digital camera 10 is further improved.

In the digital camera 10 of the embodiment, as shown in FIG. 8, the finder part 20 is disposed at the upper left corner portion of the main body rear surface 14, the opening portion 82 is disposed at a lower position of the finder part 20 in the vertical axis V1, and the opening portion 84 is disposed on the right side of the opening portion 82. However, the present invention is not limited thereto. For example, the finder part 20 may be disposed at an upper right corner portion of the main body rear surface 14, the opening portion 82 may be disposed at a lower position of the finder part 20 in the vertical axis V1, and the opening portion 84 may be disposed on a left side of the opening portion 82. In addition, although the digital camera 10 comprising the monitor unit 50 provided on the main body rear surface 14 has been exemplified, the disposition position of the monitor unit 50 is not limited to the main body rear surface 14, and the monitor unit 50 may be provided on the main body. In addition, a display device that does not have a touch panel function may be used as the display device.

Although the digital camera 10 has been described as an example of the imaging apparatus according to the embodiment of the present invention, the present invention may be subjected to some improvements or modifications without departing from the spirit of the present invention.

### EXPLANATION OF REFERENCES

10: digital camera
12: main body
14: main body rear surface
16: main body front surface
18: main body upper surface
20: finder part
22: slide switch
24: play button
26: lens unit
28: strobe light emission unit
30: release button
32: dial
50: monitor unit
52: display region
54: display region
60: display device
62: display member
64: touch panel member
64A: region
64B: region
70: glass plate
72: glass plate
80: cover member
82: opening portion
84: opening portion
86: cover substrate
88: sheet
90A: double-sided adhesive tape
90B: double-sided adhesive tape
90C: double-sided adhesive tape
90D: double-sided adhesive tape
90E: double-sided adhesive tape
G: gap
C1: centroid position
C2: centroid position
C3: centroid position
V1: vertical axis
V2: vertical axis

What is claimed is:

1. An imaging apparatus comprising:
a monitor unit in a main body,
wherein the monitor unit has one display device,
the display device is provided with a first display region and a second display region, and
the imaging apparatus further comprises a cover member having a first opening portion and a second opening portion that expose the first display region and the second display region, respectively, in a separated manner.

2. The imaging apparatus according to claim 1,
wherein the display device has a touch panel function, and
the display device includes a first operation input member corresponding to the first display region and a second operation input member corresponding to the second display region.

3. The imaging apparatus according to claim 2,
wherein the first operation input member and the second operation input member are made of a glass member.

4. The imaging apparatus according to claim 1,
wherein the cover member is fixed to the monitor unit, and
a fixing member that fixes the cover member and the display device to each other is provided between the cover member and the display device.

5. The imaging apparatus according to claim 4,
wherein the fixing member is a double-sided adhesive tape.

6. The imaging apparatus according to claim 1,
wherein the monitor unit is provided on a main body rear surface that is a rear surface of the main body, and a lens unit having an optical axis is provided on a main body front surface opposite to the main body rear surface, and
in a case where the main body rear surface is viewed in a direction along the optical axis, the optical axis is positioned in the second opening portion.

7. The imaging apparatus according to claim 6,
wherein a finder part is provided on the main body rear surface, and
in a case where the main body rear surface is viewed in a direction along the optical axis, the first opening portion and the finder part are provided so as to include a first axis along a direction intersecting the optical axis.

8. The imaging apparatus according to claim 7,
wherein, in a case where the main body rear surface is viewed in a direction along the optical axis,
the finder part is disposed at an upper left corner portion or an upper right corner portion of the main body rear surface,
the first opening portion is disposed at a lower position of the finder part on the first axis, and
the second opening portion is disposed on a right side or a left side of the first opening portion.

9. The imaging apparatus according to claim 1,
wherein the first display region is a display region in which information related to imaging is displayed.

10. The imaging apparatus according to claim 1,
wherein the second display region is a display region in which a captured image is displayed.

11. The imaging apparatus according to claim 10,
wherein the captured image is displayed in the second display region with a vertically long aspect ratio.

12. The imaging apparatus according to claim 1,
wherein the first opening portion has a smaller area than the second opening portion.

13. The imaging apparatus according to claim 12,
wherein the second opening portion has a vertically long quadrangular shape.
